(19) United States
(12) Patent Application Publication
(10) Pub. No.: US 2024/0323695 A1
(43) Pub. Date: Sep. 26, 2024

(54) COMPUTER GENERATED SECURITY FOR VERBAL COMMUNICATIONS WHEN USING A SMART DEVICE

(71) Applicant: International Business Machines Corporation, Armonk, NY (US)

(72) Inventors: Carolina Garcia Delgado, Zapopan (MX); Al Chakra, Apex, NC (US); Jonathan Cottrell, Canandaigua, NY (US); Brianne Boldrin, Cary, NC (US)

(21) Appl. No.: 18/123,514

(22) Filed: Mar. 20, 2023

(51) Int. Cl. H04W 12/63; H04W 12/30

(52) U.S. Cl. CPC H04W 12/63; H04W 12/30

(57) ABSTRACT

Security for verbal communications when using a smart device within range of other communications devices can include detecting a verbal communication on a primary device by a user to determine when the verbal communication is confidential. Analysis is implemented of an audio input using natural language processing, and when a confidential communication is in session, a designation is initiated. Further analysis is implemented to detect a geolocation of one or more secondary devices to the primary device. Responsive to determining the geolocation for one or more secondary devices is below the predetermined threshold, initiating a disengaging action to discourage audio communication to an audio input of the one or more secondary devices.

### BACKGROUND

The present invention relates generally to the field of security for communications when a user is verbally communicating using a computer device such as a smart device.

Video and voice calls are frequently held over one or more IoT (internet of things) devices with one or more user participants each typically on their own user device. Two or more participants on an audio or video call can exchange text data, slide decks, and verbal information. While verbally communicating on a user device, it is possible to have the audio output on speakerphone or connected to headphones, either with a wire or wirelessly.

Confidential information is frequently verbally discussed over conference video or calls while participating on different user devices and possibly with the participants in different environments. For example, in the same confidential conference call one participant is participating from their home office and another participant is participating from a public location, such as a coffee shop or park. For example, when a user is verbally communicating using a smart device, other devices which may have an audio input, can be within range of picking up the user's communication.

### SUMMARY

According to one embodiment of the present invention, a computer-implemented method for securing communications when using a smart device within range of other communications devices is disclosed. The computer-implemented method includes detecting a verbal communication on a primary device by a user. The computer-implemented method further includes determining when the verbal communication is confidential by analyzing an audio input using natural language processing (NLP) and designating a confidential communication is in session. The computer-implemented method further includes detecting a geolocation of one or more secondary devices to the primary device. The computer-implemented method further includes determining, using the computer, the geolocation for the one or more secondary devices is below a predetermined threshold for distance from the primary device. The computer-implemented method further includes initiating a disengaging action to discourage audio communication to an audio input of the one or more secondary devices; in response to determining the geolocation for the one or more secondary devices is below the predetermined threshold.

According to another embodiment of the present invention, a computer program product for securing communications when using a smart device within range of other communications devices is disclosed. The computer program product includes one or more computer readable storage media and program instructions stored on the one or more computer readable storage media. The program instructions include instructions to detect a verbal communication on a primary device by a user. The program instructions further include instructions to determine when the verbal communication is confidential by analyzing an audio input using NLP and designating a confidential communication is in session. The program instructions further include instructions to detect a geolocation of one or more secondary devices to the primary device. The program instructions further include instructions to determine the geolocation for the one or more secondary devices is below a predetermined threshold for distance from the primary device. The program instructions further include instructions to initiate a disengaging action to discourage audio communication to an audio input of the one or more secondary devices; in response to determining the geolocation for the one or more secondary devices is below the predetermined threshold.

According to another embodiment of the present invention, a computer system for securing communications when using a smart device within range of other communications devices is disclosed. The computer system includes one or more computer processors, one or more computer readable storage media, and computer program instructions, the computer program instructions being stored on the one or more computer readable storage media for execution by the one or more computer processors. The program instructions include instructions to detect a verbal communication on a primary device by a user. The program instructions further include instructions to determine when the verbal communication is confidential by analyzing an audio input using NLP and designating a confidential communication is in session. The program instructions further include instructions to detect a geolocation of one or more secondary devices to the primary device. The program instructions further include instructions to determine the geolocation for the one or more secondary devices is below a predetermined threshold for distance from the primary device. The program instructions further include instructions to initiate a disengaging action to discourage audio communication to an audio input of the one or more secondary devices; in response to determining the geolocation for the one or more secondary devices is below the predetermined threshold.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of computing environment, suitable for the execution of at least some of the computer code involved in performing the inventive methods, in accordance with at least one embodiment of the present invention.

FIG. 2 is a confidential communication system 200, in accordance with at least one embodiment of the present invention.

FIG. 3 is a schematic diagram of a communications environment, in accordance with at least one embodiment of the present invention.

FIG. 4 is a flow chart diagram depicting operational steps for confidential communication system, in accordance with at least one embodiment of the present invention.

FIG. 5 is a functional block diagram depicting a confidential communication system, in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

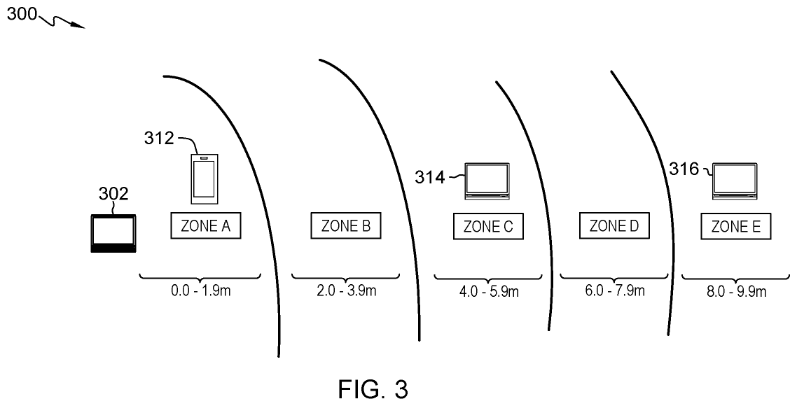

Embodiments of the present invention recognize the need to minimize security exposures during online audio communications where participants can ensure that each participant's environment is secure. Embodiments of the present invention recognize the need to stop other unauthorized devices with audio input from recording and/or uploading a private communication. Embodiments of the present invention determine a dictionary or list of confidential words. Embodiments of the present invention determine an active conference call by either user input or detecting a confidential word is spoken from the confidential list of words. Embodiments of the present invention detect an IoT device from different users when there are two or more users in different calls in close location proximity. Embodiments of the present invention determine the geolocation for one or more devices participating in the active conference call. Embodiments of the present invention determine authorized devices such as primary devices from unauthorized users or management systems, such as secondary devices. An authorized device includes user devices permitted to attend, join, or listen to a confidential communication. Further, embodiments of the present invention determine the distance between the determined authorized device and one or more detected unauthorized IoT devices, such as a secondary device. As depicted in FIG. 3, embodiments of the present invention determine one or more zones based on the geolocation for secondary devices not participating or are unauthorized in the active conference call.

Embodiments of the present invention disconnect the primary device from the network or communication channel to prevent the recording and potential uploading of the confidential conversation. Embodiments of the present invention disconnect or disable the listening functionality of a primary device based on a zone of a secondary device. For example, when a secondary device is too close to the primary device, embodiments of the present invention disconnect the primary device from the network to cease transmission of the confidential verbal information. Additional embodiments of the present invention require one or more participating users in the confidential conversation or conference call to use a secure means of communication, such as a wired communication device. For example, embodiments of the present invention display a message on the screen of the primary device indicating the participant must connect a secure means of communication, such as headphones. In these embodiments, if a user fails to meet the requirement of using a secure means of communication, the primary device is removed from the conference call in order to prevent the recording and upload of the confidential conversation.

Embodiments of the present invention protect confidential information when two or more conference calls are happening simultaneously in nearby locations. When confidential information is discussed in public locations, embodiments of the present invention require all participants to use a wired communication device versus a wireless device to protect confidential information from being recorded or intercepted by a third party. Such as wired headphones versus wireless headphones. In an embodiment, one or more participants to the confidential conference call can require one or more other participants to the confidential conference to use a secure wired communication. In some embodiments of the present invention, all IoT devices in the participants network can be disconnected from the network to protect confidential information from being recorded, heard by, or transmitted to a third party.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

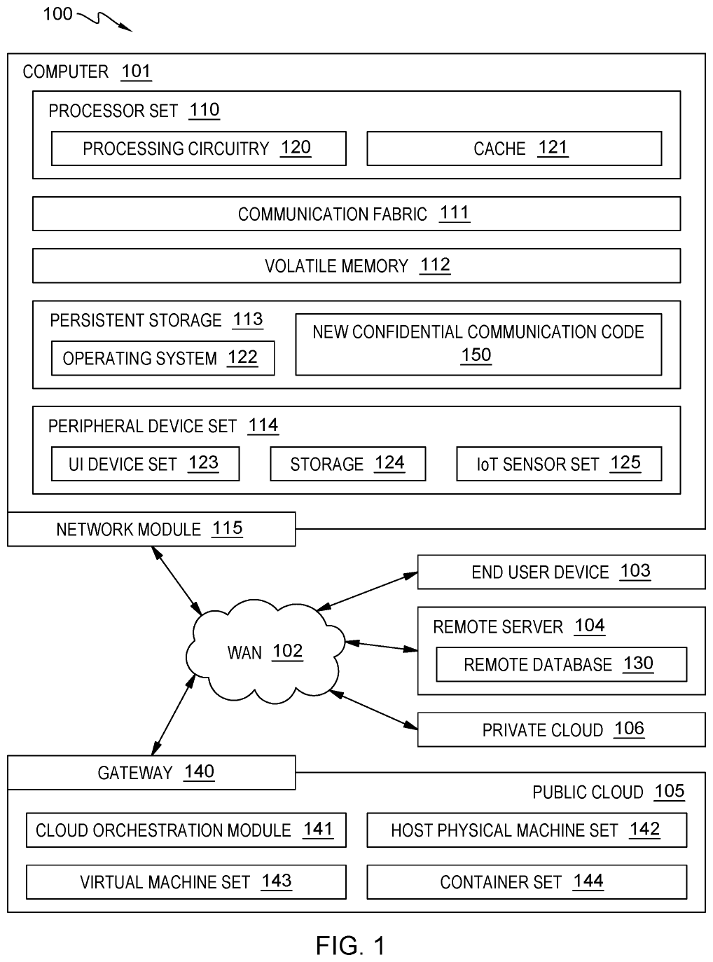

The present invention will now be described in detail with reference to the Figures. FIG. 1 is a functional block diagram of computing environment, generally designated 100, suitable for the execution of at least some of the computer code involved in performing the inventive methods, such as new confidential communication code 150, in accordance with at least one embodiment of the present invention. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. n embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In an embodiment, a database may include personal data, content, contextual data, or information related to a user. Consent for accessing and storing such personal data can include opt-in consent which can impose on the user taking an action, that is, authorizing access and storage of data, before personal data is processed. Alternatively, opt-out consent can impose on the user to take an action to prevent the processing of personal data before personal data is processed. In an embodiment, confidential communication system provides information regarding personal data and the nature (e.g., type, scope, purpose, duration, etc.) of the processing. In an embodiment, confidential communication system provides a user with copies of stored personal data. In an embodiment, speech confidential communication system allows for the correction or completion of incorrect or incomplete personal data. In an embodiment, confidential communication system allows for the immediate deletion of personal data. In an embodiment, confidential communication system provides informed consent, with notice of configuring microphone settings, network connections, and device power and requires opt-in consent before altering any microphone settings, network connections, and device power. Alternatively, opt-out consent can impose on the user to take an affirmative action to prevent configuring microphone settings, network connections, and device power.

In an embodiment, confidential communication system is represented by new confidential communication system code 150. In an embodiment, confidential communication system determines a database, dictionary or list of one or more confidential words, terms, or phrases. For example, a confidential phrase is “social security number,” “home address,” or “confirmation code.” In an embodiment confidential communication system determines a default list of confidential words, terms, or phrases. In an embodiment, the confidential word list is configurable or customizable. For example, the confidential list is customizable based, at least in part, on the user or particular company's need. For example, the same term which is confidential to one user may not be confidential to another user. In an embodiment, confidential communication system receives user input of one or more confidential words or terms. For example, confidential communication system receives a list of one or more confidential words or terms.

In an embodiment, confidential communication system detects a verbal communication on a primary device. In an embodiment, confidential communication system determines a confidential conference call or communication is in session. In an embodiment, confidential communication system determines a confidential conference call is in session by receiving user input a confidential call is in session and confidential communication system initiates secure communications. In an embodiment, the user input includes information requiring all participants to the conference call to use a secured means of communication. In an embodiment, confidential communication system determines one or more phrases, words, or terms from the confidential word list is spoken during the conference call and further determines a confidential conference call is in session. In an embodiment, confidential communication system determines one or more phrases, words, or terms from the confidential word list are present on any presentation material or digital chat and further determines a confidential conference call is in session. In an embodiment, confidential communication system utilizes any known in the art natural language processing (NLP) algorithms to determine words, phrases, or sentences present in the confidential communication platform, webpage, chat box, or primary device user interface. In an embodiment, confidential communication system utilizes an NLP algorithm to analyze audio input.

In an embodiment, confidential communication system detects a confidential communication on a primary device by a user is in session by detecting the confidentiality of the communication as meeting a threshold for initiating secure communications. For example, confidential communication system detects enough confidential words on the primary user device user interface or detects enough confidential words are spoken to exceed a threshold. In an embodiment, confidential communication system detects a confidential communication on a primary device by a user is in session by detecting speech within the communication as meeting a threshold for initiating secure communications. For example, the threshold for initiating a secure communication can include a certain number of confidential words over a predetermined threshold are spoken. For example, the threshold for initiating a secure communication is three words spoken are detected on the confidential word list, when three or more words are detected spoken on the confidential word list, confidential communication system initiates secure communications.

In an embodiment, confidential communication system determines primary and secondary user devices. In an embodiment, a primary user device is a device participating in the confidential communication or is authorized to hear the confidential communication. In an embodiment, a secondary user device is a device not participating in the confidential communication or not authorized to hear the confidential communication. In an embodiment, confidential communication system detects one or more primary or secondary devices based on heat, Wi-Fi, or geolocation. In an embodiment, confidential communication system determines one or more primary or secondary devices based on receiving informed consent or opt-in information from a primary or secondary device.

In an embodiment, confidential communication system detects one or more secondary devices communicating with the primary device. In an embodiment, a secondary device communicates with the primary device by transmitting information to or receiving information from the secondary device. In an embodiment, confidential communication system detects one or more secondary devices communicating with the primary device by determining the primary and secondary devices are both connected to the same network.

In an embodiment, confidential communication system determines a geolocation for one or more detected user devices. In an embodiment, confidential communication system determines a geolocation for a user device by utilizing a global positioning system (GPS), determining location based on connected Wi-Fi, network, or cellphone towers, heat, or any other known location or positioning method. For example, if two users are both participating in the same confidential audio call on their respective user devices, confidential communication system determines a first user user device's location is at an office and a second user user device's location is at a restaurant. In some embodiments responsive to confidential communication system determining the geolocation for a user device participating in a confidential communication is in a public location, confidential communication system requests the user on the primary device to use headphones or automatically disconnects the user device from the confidential communication. In an embodiment, confidential communication system determines one or more disengaging actions responsive to determining a user is in a public location based on selected policy. For example, a different policy with different disengaging actions may be selected if all primary devices are detected in at work verses if one or more primary devices are detected in a public area.

In an embodiment, confidential communication system determines a geolocation for one or more detected secondary user devices. For example, confidential communication system determines user A is participating in a confidential communication at a coffee shop and three other secondary user devices are detected not participating in the confidential communication nearby user A. In an embodiment, confidential communication system determines a device is capable of recording or receiving audio. In an example. confidential communication system determines a device is capable of recording or receiving audio by accessing the settings of a device to determine the device includes a microphone.

In an embodiment, confidential communication system categorizes each detected secondary device in a zone of distance. In an embodiment, confidential communication system determines one or more zones of distance respective to the primary user device. In an embodiment, the one or more zones are incremental distances from the primary user device. For example, a distance of 0.0 to 2.0 meters from the primary device is Zone One and a distance of 2.1 to 4.0 meters from the primary device is Zone Two. In an embodiment, confidential communication system categorizes the distances of each of the one or more secondary devices into one or more zones. In an embodiment, the one or more zones are determined by the distance of each of the one or more detected secondary user devices from the primary user device. For example, if a first secondary device is detected at 3 meters and a second secondary device is detected at 8 meters, confidential communication system determines a first zone of 0-4.9 meters and a second zone of 5-10 meters. Here, confidential communication system further determines the first secondary device is located in the first zone and the second secondary device is located in the second zone.

In an embodiment, confidential communication system dynamically determines one or more location zones for detected user devices based, at least in part, on the distance from the primary device to one or more secondary devices. For example, if confidential communication system determines a secondary device is 12 meters from the primary device, confidential communication system determines three location zones of Zone A 0-5 meters, Zone B 5.01-10 meters, and Zone C 10.01-15 meters from the primary device. Here the secondary device is in Zone C.

In an embodiment, confidential communication system utilizes one or more policies to determine a disengaging action to discourage audio communication to an audio input. In an embodiment, a disengaging action can include disconnecting, disabling a microphone or speaker functionalities, or an alert recommending a more secured way to communicate on a primary or secondary device. In an embodiment, the policies include information describing different decision-making actions confidential communication system should perform depending on the distance between the primary and secondary devices, number of detected devices, current audio settings of the primary device (speakerphone or headphones), and the surrounding environment in which the primary device is located. For example, the policies may include one disengaging action for two detected secondary devices where the primary device is located in the user's private home and different disengaging action for two detected secondary devices where the primary device is located in a public area. Policy outcomes for disengaging actions can include disconnecting a primary device or secondary device from the network. In an embodiment, confidential communication system disconnects or disable listening functionalities on a primary or secondary device based on the policy outcome. In an embodiment, confidential communication system initiates an disengaging action including an electronic communication in response to determining the confidential communication on the primary device by the user is in session. In an embodiment, the disengaging action initiated by the confidential communication system is the policy outcome.

In an embodiment, disconnecting a primary user device can include removing the primary device from the active confidential communication platform, disconnecting the primary device from the network, disconnecting the microphone or speakerphone from the primary device, or shutting off the primary device. In an embodiment, confidential communication system Communicates, the action to the primary device, and/or the one or more secondary devices. In an embodiment, recommending a more secured way to communicate can include a pop-up message on the primary user device recommending the user move to a more secure area, turn off speakerphone, or use wired headphones. In an embodiment, confidential communication system requires one or more users participating in the confidential call or communication to utilize a secure means of audio communication. For example, a secure means of audio communication includes headphones, wired headphones, microphone, or a wired microphone.

In embodiments where confidential communication system provides informed consent, with notice of configuring microphone settings, network connections, and device power and requires opt-in consent to the secondary device and informed consent is received, confidential communication system can disconnect a secondary device from the network to prevent the recording and uploading of confidential information. In an embodiment, disconnecting a secondary user device can include disconnecting the secondary device from the network, disconnecting the microphone or speakerphone from the secondary device, or shutting off the secondary device.

In an embodiment, if the user is allowed to continue to remain connected in the confidential communication call, the user can be alerted with an emitted sound or a popup on their device that there are other secondary user devices nearby. For example, a pop-up message appears on the user device of the primary user device stating a message that a secondary user device is detected 5 meters away from the primary user device.

In an embodiment, confidential communication system determines the geolocation for the one or more secondary devices is below a predetermined threshold distance from the primary device. For example, if the predetermined threshold distance from the primary device is 5 meters and the secondary device determined geolocation is 4 meters from the primary device, the secondary device geolocation is below the predetermined distance threshold. In an embodiment, confidential communication system disconnects or disable listening functionalities on a primary device from a confidential communication if the distance between a primary and secondary device is below a predetermined threshold. For example, if the predetermined distance between a primary and secondary user device is 5 feet away, if a device not participating in the confidential communication, the secondary device, is detected 3 feet away from the user device participating in the confidential communication, the primary device, confidential communication system disconnects the user device participating in the confidential communication, the primary user device. In another example, confidential communication system disconnects the user device not participating in the confidential communication, the secondary user device.

In an embodiment, confidential communication system disconnects a primary device from a confidential communication based on the number of secondary devices detected in one or more location zones. For example, if the predetermined threshold to disconnects a primary device from a confidential communication is one secondary device in Zone A (1-2 meters), confidential communication system disconnects the primary device responsive to determining at least one secondary device is detected in Zone A.

In an embodiment, confidential communication system disconnects a primary user device from a confidential communication if a predetermined number of secondary user devices are detected. For example, if the threshold for detected devices not participating in the confidential communication, secondary user devices, is two user devices, if confidential communication system detects three or more user devices, confidential communication system disconnects the primary user device from a confidential communication. In an embodiment, confidential communication system automatically disconnects the primary device from confidential communication. In an embodiment, automatically disconnecting the primary device from confidential communication comprises ending a voice or video call, exiting a communication application or platform, disconnecting the primary device from Wi-Fi or cellular service, or shutting off the primary device.

In an embodiment, confidential communication system receives permission from the user to connect or disconnect IoT device's from a particular network the user has ownership of. In an embodiment, confidential communication system communicates directly with a router to remove a local IoT device from a user's network or a local area network (LAN). This ensures a secondary device cannot upload the confidential communication from the primary device. In an embodiment where confidential communication system received user permission, confidential communication system communicates to a router to turn off or shut down the internet connection. For example, confidential communication system shuts down a users own network or disconnects the users own device from a network. In an embodiment, a user's network or LAN is the user's own personal network such as their at home wifi. For example, confidential communication system disconnects all IoT devices from a home wifi network or turns off the local network home wifi. This prevents the IoT device from leaking data to any unauthorized users or secondary devices. In an embodiment, confidential communication system receives permission from the user of a device to access the settings of the user's device to determine if the device includes a microphone.

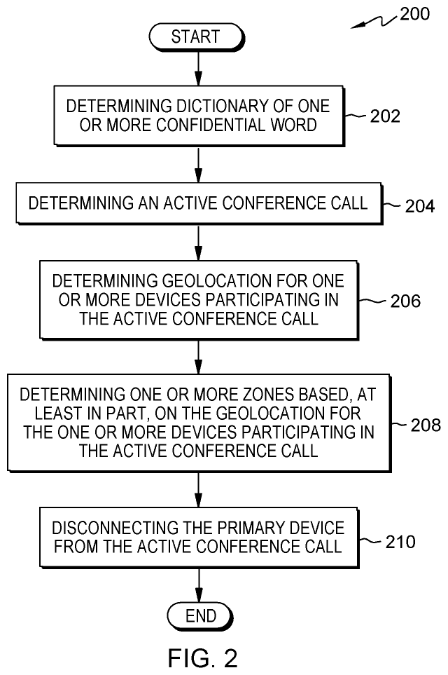

Referring to FIG. 2, a confidential communication system 200, in accordance with at least one embodiment of the present invention includes an implementation of the present disclosure and does not imply any limitations with regard to the environments in which different embodiments may be implemented. Many modifications to the depicted environment may be made by those skilled in the art without departing from the scope of the invention as recited by the claims.

The confidential communication system 200 determines a dictionary of one or more confidential words. In an embodiment, confidential communication system receives a list of one or more confidential words as user input or utilizes a default list of one or more confidential words as the dictionary, as shown in block 202.

The confidential communication system determines an active conference call, as shown in block 204. In an embodiment, confidential communication system receives user input there is an active conference call. In an embodiment, confidential communication system determines there is an active conference call responsive to determining a word from the dictionary of confidential words is spoken.

The confidential communication system determines the geolocation for one or more devices participating in the active conference call, as shown in block 206. In an embodiment, confidential communication system determines the geolocation for the primary device. In an embodiment, confidential communication system determines the distance of the primary device and one or more detected secondary devices.

The confidential communication system determines one or more zones based, at least in part, on the geolocation for the one or more devices participating in the active conference call, as shown in block 208.

The confidential communication system disconnects the primary device from the active conference call, as shown in block 210. In an embodiment, confidential communication system deactivates listening and recording functionalities on a primary device. In an embodiment, confidential communication system disconnects a primary or a secondary device from the network.

FIG. 3 is a diagram depicting an environment for confidential communication system, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

As depicted in FIG. 3, User A is patriating in a confidential communication call on a primary device 302. In this example, primary device 302 is a computer. In this example, the incremental zone distances are 0.0-1.9 meters, 2.0-3.9 meters, 4.0-5.9 meters, 6.0-7.9 meters, and 8.0-9.9 meters from the primary user device. Zone A includes any detected devices 0.0-1.9 meters from the primary user Zone B includes any detected devices 2.0-3.9 meters from the primary user device. Zone C includes any detected devices 4.0-5.9 meters from the primary user device. Zone D includes any detected devices 6.0-7.9 meters from the primary user device. Zone E includes any detected devices 8.0-9.9 meters from the primary user device.

Confidential communication system detects a first secondary user device 312 in Zone A. Confidential communication system detects a second secondary user device 314 in Zone C. Confidential communication system detects a third secondary user device 316 in Zone E. Confidential communication system does not detect any secondary user devices in Zone B or Zone D.

In an example using FIG. 3, if the predetermined distance threshold is under 3 meters to disconnects or disable listening functionalities a primary device from a confidential communication, confidential communication system disconnects or disables the listening functionalities on primary device 302 because secondary device 312 is detected in Zone A less than 3 meters from the primary device.

In an example using FIG. 3, if the predetermined distance threshold is under 6 meters to disconnects or disable listening functionalities on a primary device from a confidential communication, confidential communication system disconnects or disables the listening functionalities on primary device 302 since secondary device 312 is detected in Zone A and secondary device 314 is detected in Zone C both less than 6 meters from primary device 302.

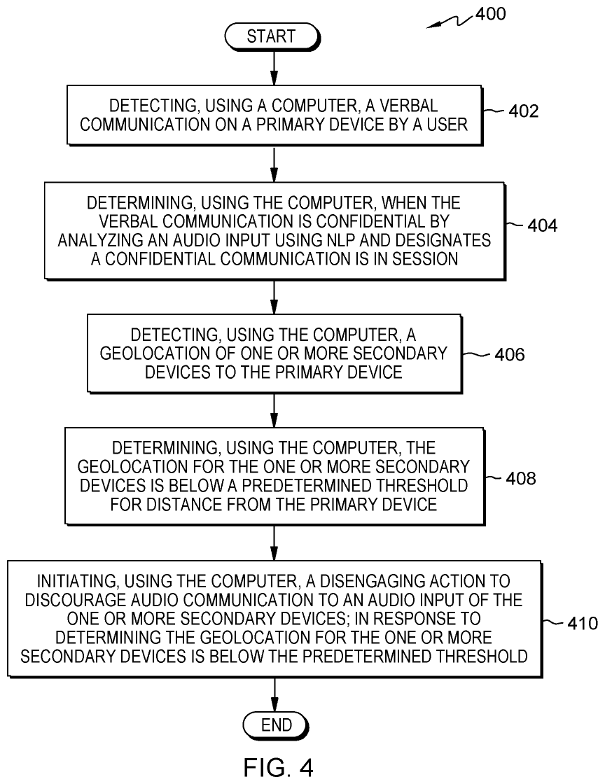

FIG. 4 is a flow chart diagram depicting operational steps for confidential communication system, generally designated 400, in accordance with at least one embodiment of the present invention. FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

The confidential communication system detects, using a computer, a verbal communication on a primary device by a user, as shown in block 402.

The confidential communication system determines, using the computer, when the verbal communication is confidential by analyzing an audio input using NLP and designates a confidential communication is in session, as shown in block 404. In an embodiment, responsive to receiving, using the computer, user input that the confidential communication is in session, confidential communication system designates a confidential communication is in session. In an embodiment, confidential communication system determines, by the computer, a dictionary of one or more confidential words. In an embodiment, confidential communication system determines, by the computer, one or more confidential words are spoken by matching a spoken word to a word in the dictionary.

The confidential communication system detects, using the computer, a geolocation of one or more secondary devices to the primary device, as shown in block 406.

The confidential communication system determines, using the computer, the geolocation for the one or more secondary devices is below a predetermined threshold for distance from the primary device, as shown in block 408. In an embodiment, confidential communication system designates, using the computer, one or more zones, wherein each of the zones are an incremental distance range from the primary device. In an embodiment the one or more zones are generated based on the geolocation of the one or more secondary devices. In an embodiment, confidential communication system categorizes, using the computer, each of the one or more secondary devices in one of the one or more zones based on the geolocation of each of the one or more secondary devices from the primary device.

The confidential communication system initiates, using the computer, a disengaging action to discourage audio communication to an audio input of the one or more secondary devices, in response to determining the geolocation for the one or more secondary devices is below the predetermined threshold, as shown in block 410. In an embodiment, the disengaging action to discourage audio communication includes one or more of disabling, by the computer, one or more listening functionalities on the primary devices, disconnecting, by the computer, the primary device from a network, or generating, by the computer, a secured audio recommendation alert. In an embodiment, confidential communication system requires, by the computer, the primary device to utilize a secure means of audio communication.

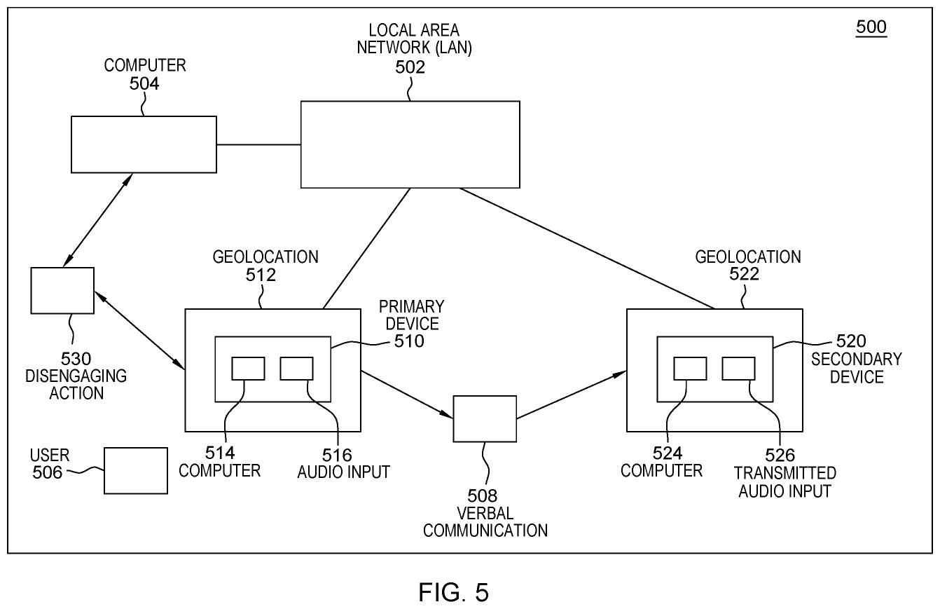

FIG. 5 is a functional block diagram for confidential communication system, in accordance with at least one embodiment of the present invention. FIG. 5 provides only an illustration of one implementation and does not imply any limitations with regard to the environments in which different embodiments may be implemented. Many modifications to the depicted environment may be made by those skilled in the art without departing from the scope of the invention as recited by the claims.

As depicted in FIG. 5, environment 500, includes Local Area Network (LAN) 502 connected to computer 504, primary device 510, and secondary device 520. In an embodiment, computer 504, primary device 510, or secondary device 520 are connected. In an embodiment, LAN 502 can include any local network confidential communication system has permission from user 506 to connect or disconnect IoT device's from a LAN 502. For example, user 506 has ownership of LAN 502. In an embodiment, computer 504 is an IoT device, a confidential communication, system, or a digital assistant. In an embodiment, computer 504 is primary device 510. In an embodiment, environment 500 further includes user 506.

As depicted, primary device 510 has a geolocation 512. Primary device 510 further includes computer 514 and audio input 516. In an embodiment, audio input 516 is the audio from a meeting, call, or other form of communication. In an embodiment, audio input 516 is received from LAN 502 or any IoT device. Secondary device 520 has a geolocation 522. Secondary device 520 further includes computer 524 and transmitted audio input 526. Primary device 510 receives audio input 516 and audibly transmits verbal communication 508. In an embodiment, and as depicted in FIG. 5, secondary device 512 receives verbal communication 508. As depicted, disengaging action 530 can be transmitted or initiated from computer 504 to primary device 510 or transmitted from primary device 510 to computer 504.

What is claimed is:

1. A computer-implemented method for securing communications when using a smart device within range of other communications devices, the computer-implemented method comprising:
detecting, using a computer, a verbal communication on a primary device by a user;
determining, using the computer, when the verbal communication is confidential by analyzing an audio input using natural language processing and designating a confidential communication is in session;
detecting, using the computer, a geolocation of one or more secondary devices to the primary device;
determining, using the computer, the geolocation for the one or more secondary devices is below a predetermined threshold for distance from the primary device; and
initiating, using the computer, a disengaging action to discourage audio communication to an audio input of the one or more secondary devices; in response to determining the geolocation for the one or more secondary devices is below the predetermined threshold.

2. The computer-implemented method of claim 1, further comprises:
designating, using the computer, one or more zones, wherein each of the zones are an incremental distance range from the primary device; and
categorizing, using the computer, each of the one or more secondary devices in one of the one or more zones based on the geolocation of each of the one or more secondary devices from the primary device.

3. The computer-implemented method of claim 1, wherein initiating the disengaging action to discourage audio communication to an audio input of the one or more secondary devices comprises one or more of:
disabling, by the computer, one or more listening functionalities on the primary devices;
disconnecting, by the computer, the primary device from a network; and
generating, by the computer, a secured audio recommendation alert.

4. The computer-implemented method of claim 1, wherein designating the confidential communication is in session further comprises:
receiving, using the computer, user input that the confidential communication is in session.

5. The computer-implemented method of claim 1, wherein designating the confidential communication is in session further comprises:
determining, by the computer, a dictionary of one or more confidential words; and
determining, by the computer, one or more confidential words are spoken by matching a spoken word to a word in the dictionary.

6. The computer-implemented method of claim 2, wherein the one or more zones are generated based on the geolocation of the one or more secondary devices.

7. The computer-implemented method of claim 1, further comprising:
requiring, by the computer, the primary device to utilize a secure means of audio communication.

8. A computer program product for securing communications when using a smart device within range of other communications devices, the computer program product comprising one or more computer readable storage media and program instructions stored on the one or more computer readable storage media, the program instructions including instructions to:
detect a verbal communication on a primary device by a user;
determine when the verbal communication is confidential by analyzing an audio input using natural language processing and designating a confidential communication is in session;
detect a geolocation of one or more secondary devices to the primary device;
determine the geolocation for the one or more secondary devices is below a predetermined threshold for distance from the primary device; and
initiate a disengaging action to discourage audio communication to an audio input of the one or more secondary devices; in response to determining the geolocation for the one or more secondary devices is below the predetermined threshold.

9. The computer program product of claim 8, further comprises instructions to:
designate one or more zones, wherein each of the zones are an incremental distance range from the primary device; and
categorize each of the one or more secondary devices in one of the one or more zones based on the geolocation of each of the one or more secondary devices from the primary device.

10. The computer program product of claim 8, wherein the instructions to initiate the disengaging action to discourage audio communication to an audio input of the one or more secondary devices comprises one or more of:
disabling one or more listening functionalities on the primary devices;
disconnect the primary device from a network; and
generate a secured audio recommendation alert.

11. The computer program product of claim 8, wherein the instructions to designate the confidential communication is in session further comprises instructions to:
receive user input that the confidential communication is in session.

12. The computer program product of claim 8, wherein the instructions to designate the confidential communication is in session further comprises instructions to:
determine a dictionary of one or more confidential words; and
determine one or more confidential words are spoken by matching a spoken word to a word in the dictionary.

13. The computer program product of claim 9, wherein the one or more zones are generated based on the geolocation of the one or more secondary devices.

14. The computer program product of claim 8, further comprising instructions to:
requiring the primary device to utilize a secure means of audio communication.

15. A computer system for securing communications when using a smart device within range of other communications devices, comprising:
one or more computer processors;
one or more computer readable storage media;
computer program instructions;
the computer program instructions being stored on the one or more computer readable storage media for execution by the one or more computer processors; and
the computer program instructions including instructions to:
detect a verbal communication on a primary device by a user;
determine when the verbal communication is confidential by analyzing an audio input using natural language processing and designating a confidential communication is in session;
detect a geolocation of one or more secondary devices to the primary device;
determine the geolocation for the one or more secondary devices is below a predetermined threshold for distance from the primary device; and
initiate a disengaging action to discourage audio communication to an audio input of the one or more secondary devices; in response to determining the geolocation for the one or more secondary devices is below the predetermined threshold.

16. The computer system of claim 15, further comprises instructions to:
designate one or more zones, wherein each of the zones are an incremental distance range from the primary device; and
categorize each of the one or more secondary devices in one of the one or more zones based on the geolocation of each of the one or more secondary devices from the primary device.

17. The computer system of claim 15, wherein the instructions to initiate the disengaging action to discourage audio communication to an audio input of the one or more secondary devices comprises one or more of:
disabling one or more listening functionalities on the primary devices;
disconnect the primary device from a network; and
generate a secured audio recommendation alert.

18. The computer system of claim 15, wherein the instructions to designate the confidential communication is in session further comprises instructions to:
receive user input that the confidential communication is in session.

19. The computer system of claim 15, wherein the instructions to designate the confidential communication is in session further comprises instructions to:
determine a dictionary of one or more confidential words; and
determine one or more confidential words are spoken by matching a spoken word to a word in the dictionary.

20. The computer system of claim 16, wherein the one or more zones are generated based on the geolocation of the one or more secondary devices.
